(19) United States
(12) Patent Application Publication
(10) Pub. No.: US 2003/0231766 A1
(43) Pub. Date: Dec. 18, 2003

(54) Shared control and information bit representing encryption key position selection or new encryption key value

(76) Inventor: Bedros Hanounik, Cupertino, CA (US)

Correspondence Address: BUCKLEY, MASCHOFF, TALWALKAR, & ALLISON, 5 ELM STREET, NEW CANAAN, CT, 06840, US

(21) Appl. No.: 10/158,343

(22) Filed: May 30, 2002

(51) Int. Cl. H04L 9/00

(52) U.S. Cl. 380/43

(57) ABSTRACT

According to some embodiments, a shared control and information bit can represent either an encryption key position selection or a new encryption key value.

### BACKGROUND

To protect and/or authenticate information, it is known that a sender can encrypt data. For example, the sender may encrypt an original message of “plaintext” to create “ciphertext,” such as by encrypting the plaintext using an encryption key in accordance with the Data Encryption Standard (DES) defined by American National Standards Institute (ANSI) X3.92 “American National Standard for Data Encryption Algorithm (DEA)” (1981). The sender can then securely transmit the ciphertext to a recipient. The recipient decrypts the ciphertext to re-create the original plaintext (e.g., using a decryption key in accordance with DES).

To increase the security of an encryption process, multiple rounds of encryption may be performed. Moreover, an encryption key may be modified between each round. For example, FIG. 1 is an overview of a DES encryption process 100 in which a function (110 is applied during each of sixteen rounds. For clarity, only some of the steps performed during a DES encryption process are described herein.

Note that a different encryption key is used for each round (i.e., K₁, K₂, . . . K₁₆). In particular, two halves of an original 56-bit encryption key are circularly shifted left by either one or two bits during each round. FIG. 2 illustrates encryption key shifting during a DES encryption process. As shown in a table 200, each encryption round 202 is associated with a number of bits to circularly shift left 204 (i.e., the encryption key is shifted left one bit during the ninth round and left two bits during the tenth round).

To further increase security, the encryption described with respect to FIGS. 1 and 2 may be performed a number of different times (e.g., with a number of different encryption keys). For example, during a triple DES process the encryption is repeated three times, and a different encryption key may be used for each of the three encryptions.

Also note that a process similar to the one described with respect to FIGS. 1 and 2 may be performed to decrypt a ciphertext message (i.e., to re-create the original plaintext). In this case, however, the encryption key may be circularly shifted to the right during each round (e.g., by one or two bit positions).

Thus, a device adapted to protect and/or authenticate information may need to shift an encryption key various numbers of bits (e.g., one or two bits) in either direction. Moreover, the device may need to load information associated with a new encryption key (e.g., during a triple DES encryption process). This type of device, however, may be inefficiently designed given the environment in which it is implemented. For example, a device may be designed for a Field-Programmable Gate Array (FPGA) environment. An FPGA is an integrated circuit that can be programmed after manufacture by connecting various Configurable Logic Blocks (CLBs), such as look-up tables, together in different ways. A design for a device adapted to protect and/or authenticate information might inefficiently use such CLBs, especially if different types of processes need to be supported (e.g., shifting an encryption key left or right by one or two bits, or loading a new encryption key).

### BRIEF DESCRIPTION OF THE DRAWINGS

FIG. 1 is an overview of a DES encryption process.

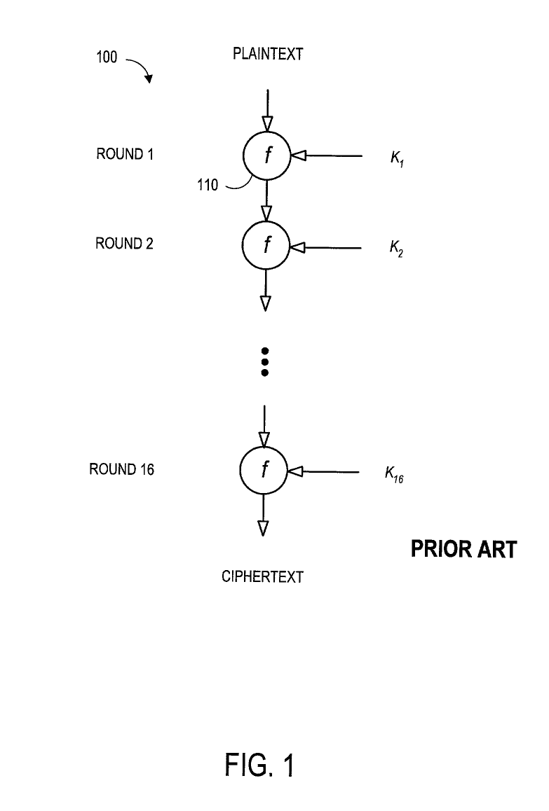

FIG. 2 illustrates encryption key shifting during a DES encryption process.

FIG. 3 is a block diagram of an encryption device for shifting encryption keys.

FIG. 4 is a block diagram of an encryption device for shifting encryption keys according to some embodiments.

FIG. 5 is a flow chart of a method of facilitating an encryption process according to some embodiments.

FIG. 6 is a block diagram of a device for facilitating an encryption process according to some embodiments.

FIG. 7 illustrates how information is stored in a memory unit according to one embodiment.

### DETAILED DESCRIPTION

Some of the described embodiments are associated with an “encryption process.” As used herein, the phrase “encryption process” may refer to a process that encrypts or decrypts data. Examples of an encryption process include DES, triple-DES as defined by ANSI X9.52 “Triple Data Encryption Algorithm Modes of Operation” (1998), and Advanced Encryption Standard (AES) as defined by Federal Information Processing Standards (FIPS) publication 197 (2002). Details about these, and other, encryption processes can be found in Bruce Schneier, “Applied Cryptography” (2nd Ed., 1996).

Encryption Devices

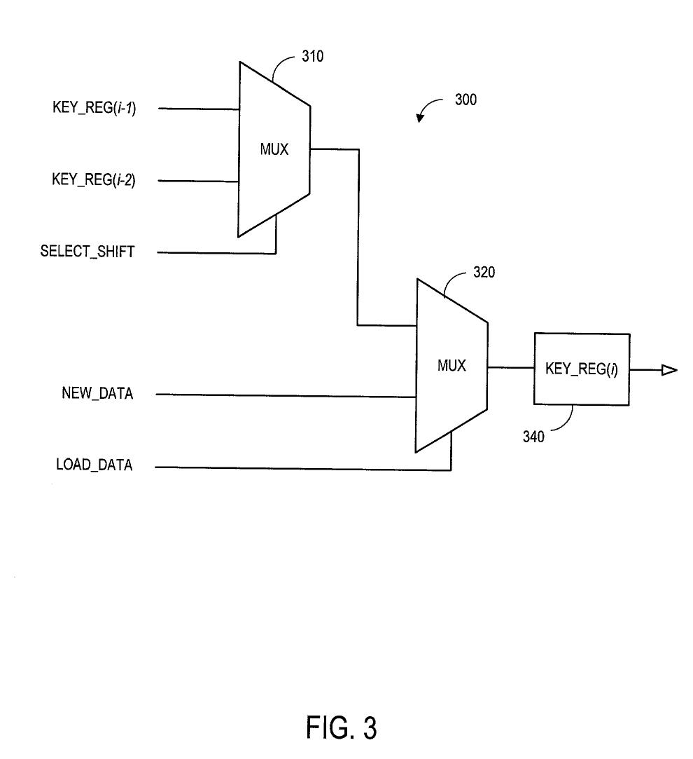

FIG. 3 is a block diagram of an encryption device 300 that might be used for shifting encryption keys. In particular, a first multiplexer 310 receives key information associated with a one-bit shift and a two-bit shift: Key_Reg(i−1) and Key_Reg(i−2). The first multiplexer 310 is controlled by a Select_Shift signal.

A second multiplexer 320 receives an output of the first multiplexer 310 along with New_Data (i.e., associated with a new encryption key). The second multiplexer 320 is controlled by a Load_Data signal. The output of the second multiplexer 320 is provided to a key register 340: Key_Reg(i). The information in the key register 340 may then be used during a round of an encryption process.

In this way, the Load_Data signal controls whether the key register 340 will receive information associated with a new encryption key (i.e., New_Data) or a one-bit or two-bit shift of the current encryption key (i.e., based on Select_Shift).

Note, however, the encryption device 300 requires five input lines. As a result, two separate Look Up Tables (LUT) are required when the appropriate logic function is implemented in an FPGA environment (i.e., each LUT can support a logic function having up to four input lines).

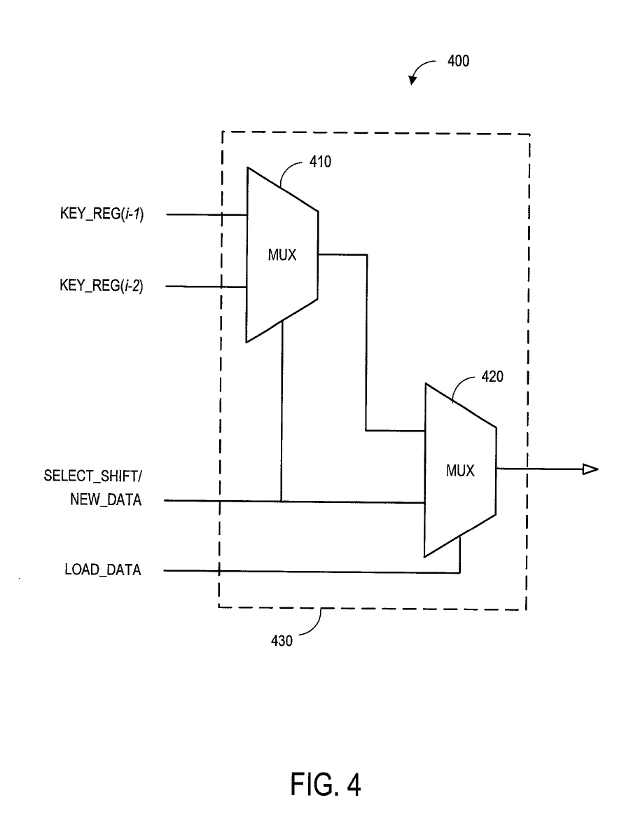

Consider now FIG. 4, which is a block diagram of an encryption device 400 that may be used for shifting encryption keys according to some embodiments. As before, a first multiplexer 410 receives key information representing a one-bit shift and a two-bit shift: Key_Reg(i−1) and Key_Reg(i−2). In this case, however, the first multiplexer 410 is controlled by a shared control and information input line: Select_Shift/New_Data.

A second multiplexer 420 receives an output of the first multiplexer 410 along with Select_Shift/New_Data and is controlled by a Load_Data signal. The output of the second multiplexer 420 may then be used during a round of an encryption process (e.g., after being stored in a key register).

In this way, the Load_Data signal controls whether a key register will receive information associated with (i) a new encryption key or (ii) a one-bit or two-bit shift of the current encryption key. Moreover, a single input line represents either a control signal (i.e., when Select_Shift/New_Data indicates whether a one-bit or two-bit shift will be applied) or an information signal (i.e., a new encryption key value). As a result, the encryption device 400 only requires four input lines—and the appropriate logic function may be implemented using a single LUT 430 in an FPGA environment (e.g., using a single FPGA slice for each bit of the encryption key). Using a single LUT 430 may reduce the area of the circuit and improve the performance of an encryption engine. According to other embodiments, the encryption device 400 is instead implemented in an Application Specific Integrated Circuit (ASIC) environment.

Encryption Method

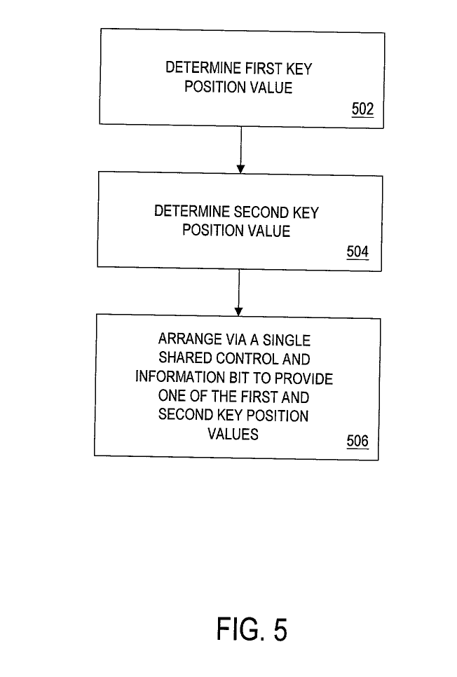

FIG. 5 is a flow chart of a method of facilitating an encryption process according to some embodiments. The method may be performed, for example, using the encryption device 400 shown in FIG. 4.

At 502, a first key position value is determined (e.g., a “0” or a “1” associated with a particular position, or bit, in an encryption key). Consider, for example, a 28-bit encryption key (e.g., half of a 56-bit DES key). In this case, the first key position value may equal “1” or a “0” associated with a current bit position i (e.g., the tenth bit of the current encryption key) after the encryption key is circularly shifted one position to the left (e.g., position i−1). Similarly, a second key position value is determined at 504. For example, the second key position value may equal the value of a current bit position after the encryption key is circularly shifted two positions to the left (e.g., position i−2).

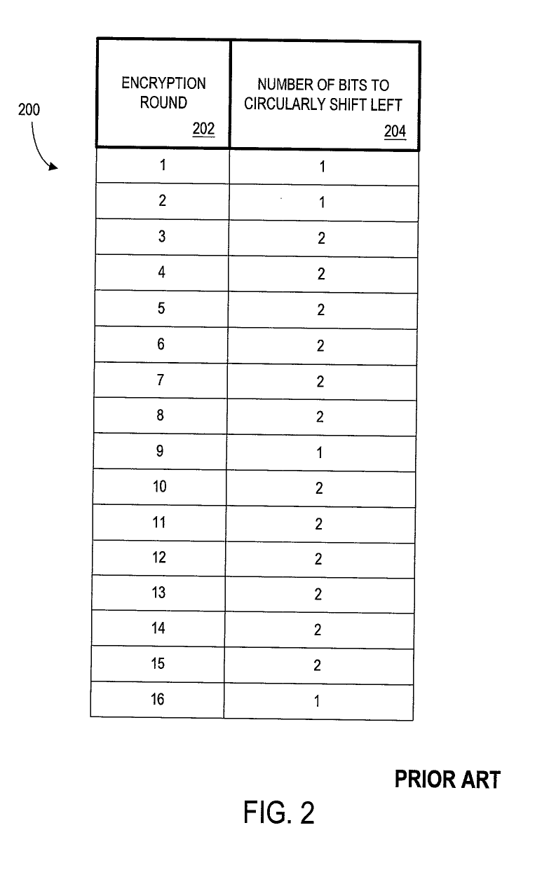

At 506, it is arranged via a shared control and information bit to provide one of the first and second key position values. Assume, for example, that the eighth round of a DES encryption process is being performed. In this case, as described with respect to FIG. 2, the encryption key will be circularly shifted two bit positions to the left. As a result, the shared control and information bit (e.g., the Select_Shift/New_Data signal described with respect to FIG. 4) is used to select the second key position value. Note that in this case, the Load_Data signal is used to select the output of the first multiplexer 410 (e.g., for use by an appropriate encryption circuit).

Moreover, according to some embodiments, a new key value is determined. For example, during a triple DES encryption process a key value associated with the second encryption key may be determined (e.g., after plaintext information has been encrypted with the first key). In this case, it is arranged via the shared control and information bit to provide the new key value (e.g., for use by an appropriate encryption circuit). For example, the Select_Shift/New_Data signal may equal the new key value and the Load_Data signal may select that value as an output from the second multiplexer 420 (e.g., for use by an appropriate encryption circuit).

Example of Encryption Device

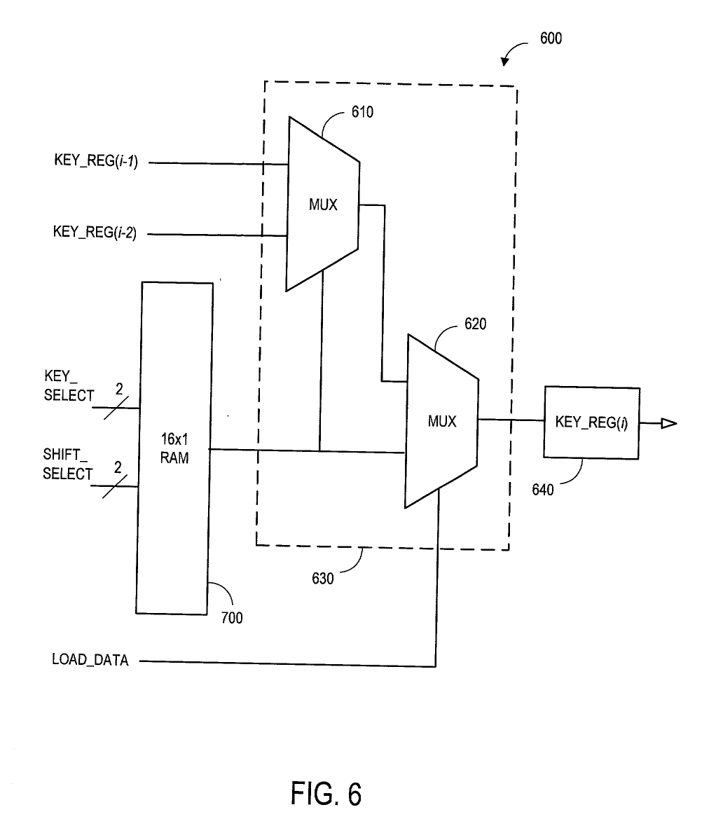

FIG. 6. illustrates one example of an encryption device 600 that may be used to facilitate an encryption process according to some embodiments. In particular, the circuit illustrated in FIG. 6 may be used to support a triple DES encryption process.

The encryption device 600 includes a shifting unit 630 similar to the circuit described with respect to FIG. 4. In particular, a first multiplexer 610 receives key information representing a one-bit shift and a two-bit shift: Key_Reg(i−1) and Key_Reg(i−2). The first multiplexer 610 is also controlled by a shared control and information input line.

A second multiplexer 620 receives an output of the first multiplexer 610 along with the shared control and information input line and is controlled by a Load_Data signal. The output of the second multiplexer 620 is then stored in a key register 640.

The shared control and information input line is provided by a memory unit 700, such as a 16×1 Random Access Memory (RAM) unit. In particular, the output of the memory unit 700 is selected via four address lines: a two-bit Key Select signal and a two-bit Shift_Select signal. Note that the memory unit 700 might also receive other signals, such as a write signal (not shown in FIG. 6).

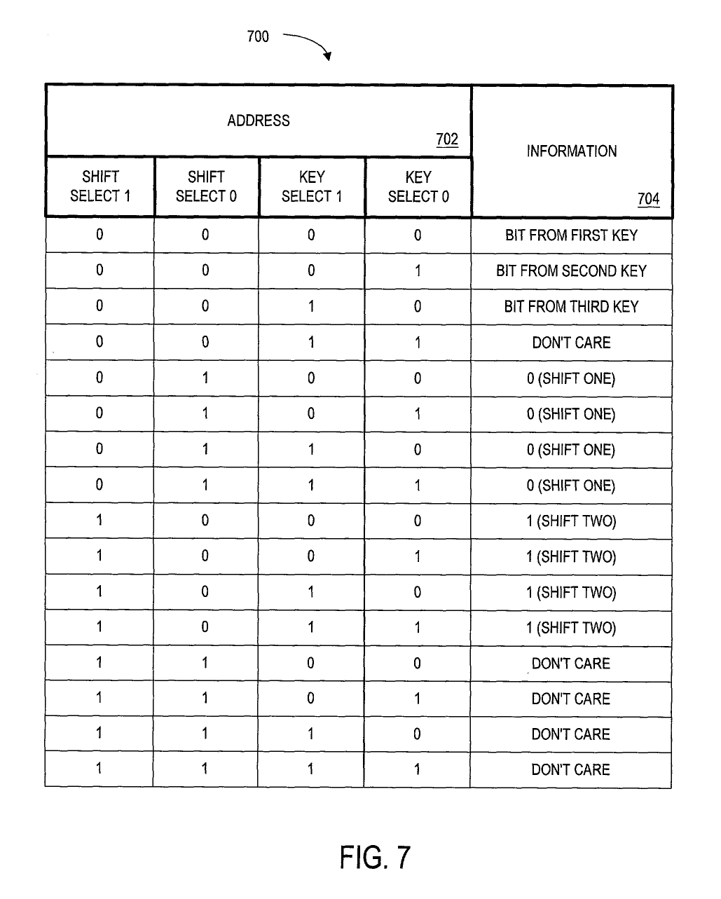

FIG. 7 illustrates how information 704 is stored in the memory unit 700 according to one embodiment. As can be seen, the two key select bits represent the two Least Significant Bits (LSBs) of the address 702 and the two shift select bits represent the two Most Significant Bits (MSBs) of the address 702.

With respect to the stored information 704, each of the first three bits are associated with a different encryption key (e.g., to be used during a triple DES encryption process). The fifth through eight bits are set to “0” (which will be associated with a one-bit shift) and the ninth through twelfth bits are set to “1” (which will be associated with a two-bit shift). The value of the remaining bits (i.e., the fourth and thirteenth through sixteenth bits) do not matter.

Consider now the operation of the encryption device 600 when a new key value needs to be loaded into the key register 640. In this case, the Key_Select signal is set to the appropriate value and Shift_Select is set to “00” (e.g., an address of “0001” would select a bit from the second key). As a result, the shared control and information signal (i.e., the output from the memory unit 700) equals the new key value. The Load_Data signal is then used to provide that value to the key register 640 through the second multiplexer 620.

Now assume that an encryption key needs to be shifted one bit position. In this case, Shift_Select is set to “01” (the value of Key_Select does not matter). As a result, the shared control and information signal (i.e., the output from the memory unit 700) will equal “0,” causing the first multiplexer 610 to output Key_Reg(i−1). The Load_Data signal is then used to provide that value to the key register 640 through the second multiplexer 620.

Similarly, if the encryption key needs to be shifted two bit positions, Shift_Select is set to “10.” As a result, the shared control and information signal (i.e., the output from the memory unit 700) will equal “1,” causing the first multiplexer 610 to output Key_Reg(i−2). The Load_Data signal is then used to provide that value to the key register 640 through the second multiplexer 620.

According to some embodiments, the encryption device 600 is implemented using a single FPGA slice for each bit of encryption key data. For example, the memory unit 700 may be implemented via a function generator, the first and second multiplexers 610, 620 may be implemented via a single LUT, and the key register 640 may be implemented via a digital flip flop. An example of an FPGA environment that may be appropriate for such an implementation is available from XILINX®. Note that appropriate encryption key and control information may be stored in the memory unit 700 as part of an FPGA configuration process.

Additional Embodiments

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

Although embodiments have been described with respect to a triple DES encryption process, other embodiments may be associated with other types of encryption processes. Also note that other memory configurations may be used in place of the arrangement described with respect to FIG. 7 (e.g., the key select bits could be address MSBs and the shift select bits could be address LSBs). Moreover, although software or hardware are described as performing certain functions, such functions may be performed using software, hardware, or a combination of software and hardware (e.g., a medium may store instructions adapted to be executed by a processor to perform a method of facilitating an encryption process). For example, functions described herein may be implemented via a software simulation of FPGA hardware.

The several embodiments described herein are solely for the purpose of illustration. Persons skilled in the art will recognize from this description other embodiments may be practiced with modifications and alterations limited only by the claims.

What is claimed is:

1. An encryption device, comprising:
a shared control and information input line adapted to receive a shared control and information bit capable of representing either a key position selection or a new key value;
an output line adapted to provide an output bit representing any one of: (i) a first key position value, (ii) a second key position value, and (iii) the new key value.

2. The encryption device of claim 1, wherein the first key position value represents an encryption key shifted by one bit and the second key position value represents the encryption key shifted by two bits.

3. The encryption device of claim 2, wherein the encryption key is circularly shifted left when encrypting information and right when decrypting information.

4. The encryption device of claim 1, further comprising:
a first key position value input line adapted to receive the first key position value;
a second key position value input line adapted to receive the second key position value; and
a load new key control line adapted to receive a load new key control signal.

5. The encryption device of claim 4, further comprising:
a first multiplexer adapted to output one of the first key position value and the second key position value based on the shared control and information bit; and
a second multiplexer adapted to output one of the first multiplexer's output and the shared control and information bit based on the load new key control signal.

6. The encryption device of claim 5, wherein the encryption device is implemented via at least one of: (i) a field-programmable gate array, and (ii) an application specific integrated circuit.

7. The encryption device of claim 6, wherein the encryption device uses a single slice of a field-programmable gate array for each bit of an encryption key.

8. The encryption device of claim 7, wherein the encryption device comprises a look up table.

9. The encryption device of claim 1, further comprising:
a key register coupled to the output line.

10. The encryption device of claim 1, further comprising:
a storage unit coupled to the shared control and information input line.

11. The encryption device of claim 10, wherein the storage unit is adapted to receive:
address information selecting one of a plurality of encryption keys; and
address information selecting a key position.

12. The encryption device of claim 11, wherein: (i) the storage unit comprises a 16×1 random access memory unit having four address lines, (ii) two of the address lines select one of at least three encryption keys, and (iii) two of the address lines select between a first key position and a second key position.

13. The encryption device of claim 1, wherein the encryption device is associated with at least one of: (i) generating a ciphertext output based on a plaintext input and an encryption key, (ii) generating a plaintext output based on a ciphertext input and an encryption key, (iii) a data encryption standard process, (iv) a triple data encryption standard process, and (v) an advanced encryption standard process.

14. A method of facilitating an encryption process, comprising:
determining a first key position value;
determining a second key position value; and
arranging via a shared control and information bit to provide one of the first key position value and the second key position value.

15. The method of claim 14, further comprising:
determining a new key value; and
arranging via the shared control and information bit to provide the new key value.

16. The method of claim 15, wherein the shared control and information bit is provided via a memory unit, and further comprising:
storing encryption key and control information in the memory unit during a configuration process.

17. A medium storing instructions adapted to be executed by a processor to perform a method of facilitating an encryption process, the method comprising:
determining a first key position value;
determining a second key position value; and
arranging via a shared control and information bit to provide one of the first key position value and the second key position value.

18. The medium of claim 17, wherein the method further comprises:
determining a new key value; and
arranging via the shared control and information bit to provide the new key value.

19. The medium of claim 17, wherein the shared control and information bit is provided via a memory unit, and the method further comprises:
storing encryption key and control information in the memory unit during a configuration process.

20. An encryption device adapted to facilitate a triple data encryption standard encryption process and comprising, for each encryption key bit:
a 16×1 random access memory unit storing encryption key information and control information for three different encryption keys and including:
two address lines adapted to select one of the three encryption keys, and
two address lines adapted to select between a first key position and a second key position; and
an output line adapted to provide a shared control and information bit capable of representing either a key position selection or a new key value;
a shifting unit, including:
a first key position value input line adapted to receive a first key position value,
a second key position value input line adapted to receive a second key position value,
a shared control and information input line adapted to receive the shared control and information bit,
a load new key control line adapted to receive a load new key control signal,
a first multiplexer adapted to output one of the first key position value and the second key position value based on the shared control and information bit; and
a second multiplexer adapted to output one of the first multiplexer's output and the shared control and information bit based on the load new key control signal; and
a key register adapted to receive the output of the second multiplexer.

21. The encryption device of claim 20, wherein the first key position value represents an encryption key shifted by one bit and the second key position value represents the encryption key shifted by two bits.

22. The encryption device of claim 20, wherein the encryption device uses a single slice of a field-programmable gate array for each bit of an encryption key.
